(19) United States
(12) Patent Application Publication
(10) Pub. No.: US 2014/0347332 A1
(43) Pub. Date: Nov. 27, 2014

(54) ORGANIC LIGHT EMITTING DISPLAY AND METHOD FOR DRIVING THE SAME

(71) Applicant: Samsung Display Co., Ltd., Yongin-City (KR)

(72) Inventor: Wook LEE, Yongin-City (KR)

(73) Assignee: SAMSUNG DISPLAY CO., LTD., Yongin-City (KR)

(21) Appl. No.: 14/199,852

(22) Filed: Mar. 6, 2014

(30) Foreign Application Priority Data
May 22, 2013 (KR) 10-2013-0057872

(51) Int. Cl. G09G 3/32

(52) U.S. Cl. CPC G09G 3/3266
USPC 345/204; 345/76

(57) ABSTRACT

An organic light emitting display and a method for driving the same are presented. The display and the method enable display of images at a substantially constant luminance level over time, even when degradation of the organic light emitting diode occurs. Components are used to compensate for the degradation of an organic light emitting diode and a difference in the threshold voltage/mobility of a driving transistor.

### RELATED APPLICATION(S)

This application claims priority to and the benefit of Korean Patent Application No. 10-2013-0057872 filed on May 22, 2013 in the Korean Intellectual Property Office, the entire contents of which are incorporated herein by reference in their entirety.

### BACKGROUND

1. Field

The present disclosure relates to an organic light emitting display.

2. Description of the Related Art

Recently, various types of flat panel displays have become available. The flat panel displays are often preferred by users because they are lighter and more compact (thinner) than the traditional mainstream displays, such as cathode ray tubes. The different types of flat panel displays include liquid crystal displays, field emission displays, plasma display panels, organic light emitting displays, and the like.

Among these flat panel displays, organic light emitting displays display images using organic light emitting diodes that emit light in response to recombination of electrons and holes. Organic light emitting displays are growing in popularity due to their fast response speed and low power consumption.

### SUMMARY

Embodiments provide an organic light emitting display and a method for driving the same that enable display of image at substantially constant luminance level over time. The display and the method incorporate components that are configured to compensate for degradation of an organic light emitting diode and a difference in the threshold voltage/mobility of a driving transistor.

According to an aspect of the present invention, there is provided an organic light emitting display, including: a pixel unit configured to include pixels arranged at intersection portions of data lines, feedback lines, scan lines and sensing control lines; a data driver configured to supply data signals to the data lines; a scan driver configured to sequentially supply scan signals to the scan lines; a sensing control line driver configured to sequentially supply a sensing control signal to the sensing control lines; and a sensing unit configured to include sensing circuits coupled to the feedback lines, wherein at least one of the sensing circuits is disposed on an i-th (i is a natural number greater than 0) vertical line and includes: an integrator configured to integrate current supplied from an i-th feedback line; a first capacitor configured to store an output voltage of the integrator; and a comparator configured to compare the output voltage stored in the first capacitor and the voltage of a first reference power source, and output a comparison result signal, based on the comparison.

The sensing unit may further include a memory configured to store a compensation data related to degradation information of an organic light emitting diode included in each pixel and threshold voltage/mobility of a driving transistor included in each pixel, and correct the compensation data, in response to the comparison result signal.

The organic light emitting display may further include a timing controller configured to correct a first data supplied from the outside of the organic light emitting display based on the compensation data stored in the memory, and supply the corrected first data as a second data to the data driver.

The data driver may supply, to the data lines, a data signal corresponding to the second data.

The integrator may include an amplifier configured to have a first input terminal coupled to the i-th feedback line, a second input terminal coupled to a second reference power source, and an output terminal coupled to the comparator; and a second capacitor coupled between the first input terminal and the output terminal

The integrator may further include a first switch coupled between the first input terminal and the output terminal, the first switch being turned on during a reset period.

A pixel disposed at an intersection portion of the i-th vertical line and a j-th (j is a natural number greater than 0) horizontal line among the pixels includes an organic light emitting diode coupled between a first node and a second power source; a first transistor coupled between an i-th data line and a second node, the first transistor being configured to turn on in response to the scan signal supplied through a j-th scan line; a storage capacitor coupled between a first power source and the second node; a second transistor configured to supply current corresponding to a voltage charged in the storage capacitor from the first power source to the second power source through the second node; and a third transistor coupled between an i-th feedback line and the first node, the third transistor being configured to turn on in response to the sensing control signal supplied through a j-th sensing control line.

The pixel may further include a second switch coupled between the second transistor and the first node, the second switch being configured to turn off during a first sensing period.

The pixel may further include a third switch coupled between the first node and the organic light emitting diode, the third switch being configured to turn off during a second sensing period.

The voltage of the second power source may be increased during the second sensing period so that current does not flow through the organic light emitting diode.

According to an aspect of the present invention, there is provided a method for driving an organic light emitting display, the method including: generating an output voltage by integrating current supplied through a feedback line during a predetermined period; comparing the output voltage with the voltage of a reference power source; correcting a compensation data stored in a memory based on the comparison; and correcting a data based on the compensation data, and adjusting the corrected data and then supplying the adjusted data to pixels.

The correcting of the compensation data may include decreasing the value of the compensation data when the output voltage is higher than the voltage of the reference power source; and increasing the value of the compensation data when the output voltage is lower than the voltage of the reference power source.

### BRIEF DESCRIPTION OF THE DRAWINGS

Example embodiments will now be described more fully with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the figures, dimensions may be exaggerated for clarity of illustration. It will be understood that when an element is referred to as being “between” two elements, it may be the only element between the two elements, or one or more intervening elements may also be present. Like reference numerals refer to like elements throughout.

FIG. 1 is a block diagram illustrating an organic light emitting display according to an embodiment of the present invention.

FIG. 2 is a circuit diagram illustrating in detail a pixel shown in FIG. 1.

FIG. 3 is a circuit diagram illustrating a connection structure of the pixel, a sensing unit and a timing controller, shown in FIG. 1.

FIG. 4A is a waveform diagram of control signals supplied to the pixel, the sensing unit and the timing controller, shown in FIG. 3, during a display period.

FIG. 4B is a circuit diagram illustrating operations of the pixel, the sensing unit and the timing controller, shown in FIG. 3, during the display period.

FIG. 5A is a waveform diagram of control signals supplied to the pixel, the sensing unit and the timing controller, shown in FIG. 3, during a first sensing period.

FIG. 5B is a circuit diagram illustrating operations of the pixel, the sensing unit and the timing controller, shown in FIG. 3, during the first sensing period.

FIG. 6A is a waveform diagram of control signals supplied to the pixel, the sensing unit and the timing controller, shown in FIG. 3, during a second sensing period.

FIG. 6B is a circuit diagram illustrating operations of the pixel, the sensing unit and the timing controller, shown in FIG. 3, during the second sensing period.

FIG. 7 is a flowchart illustrating a method for driving the organic light emitting display according to an embodiment of the present invention.

### DETAILED DESCRIPTION

Hereinafter, certain exemplary embodiments according to the present disclosure will be described with reference to the accompanying drawings. When a first element is described as being coupled to a second element, the first element may be not only directly coupled to the second element but may also be indirectly coupled to the second element via a third element. Further, some of the elements that are not essential to the complete understanding of the disclosure are omitted for clarity. Also, like reference numerals refer to like elements throughout.

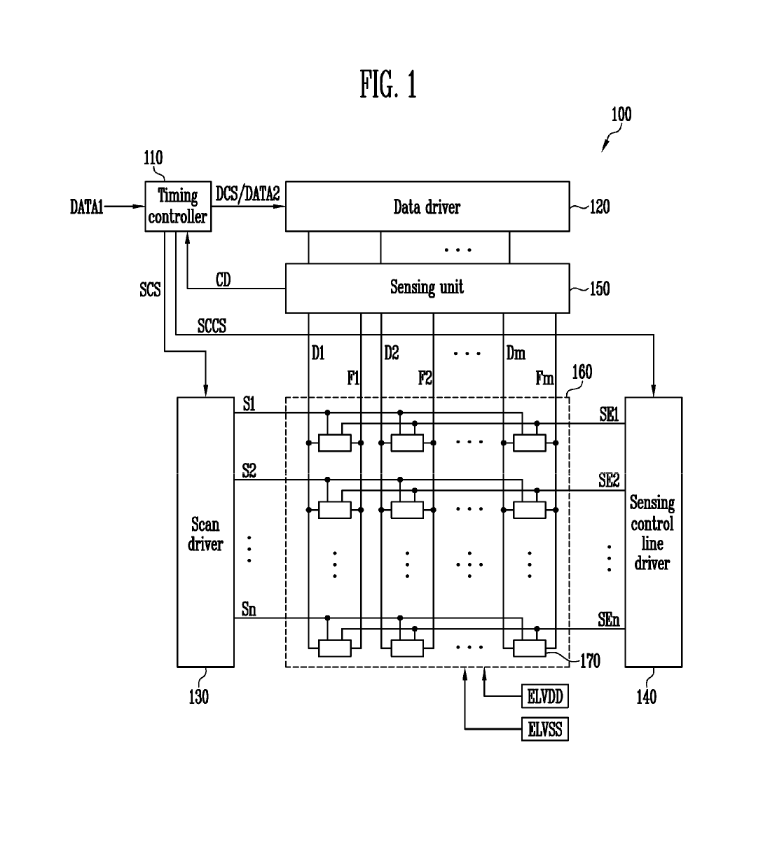

FIG. 1 is a block diagram illustrating an organic light emitting display according to an embodiment of the inventive concept.

Referring to FIG. 1, the organic light emitting display 100 according to this embodiment includes a timing controller 110, a data driver 120, a scan driver 130, a sensing control line driver 140, a sensing unit 150 and a pixel unit 160.

The timing controller 110 may control operations of the data driver 120, the scan driver 130, the sensing control line driver 140 and the sensing unit 150 in response to a synchronization signal (not shown) received from a unit outside of the organic light emitting display. The timing controller 110 may generate data driving control signals DCS and supply the generated data driving control signals DCS to the data driver 120. The timing controller 110 may generate a scan driving control signal SCS and supply the generated scan driving control signal SCS to the scan driver 130. The timing controller 110 may generate a sensing control line driving control signal SCCS and supply the generated sensing control line driving control signal to the sensing control line driver 140. The timing controller 110 may generate switching control signals (not shown) and supply the generated switching control signals to the sensing unit 150.

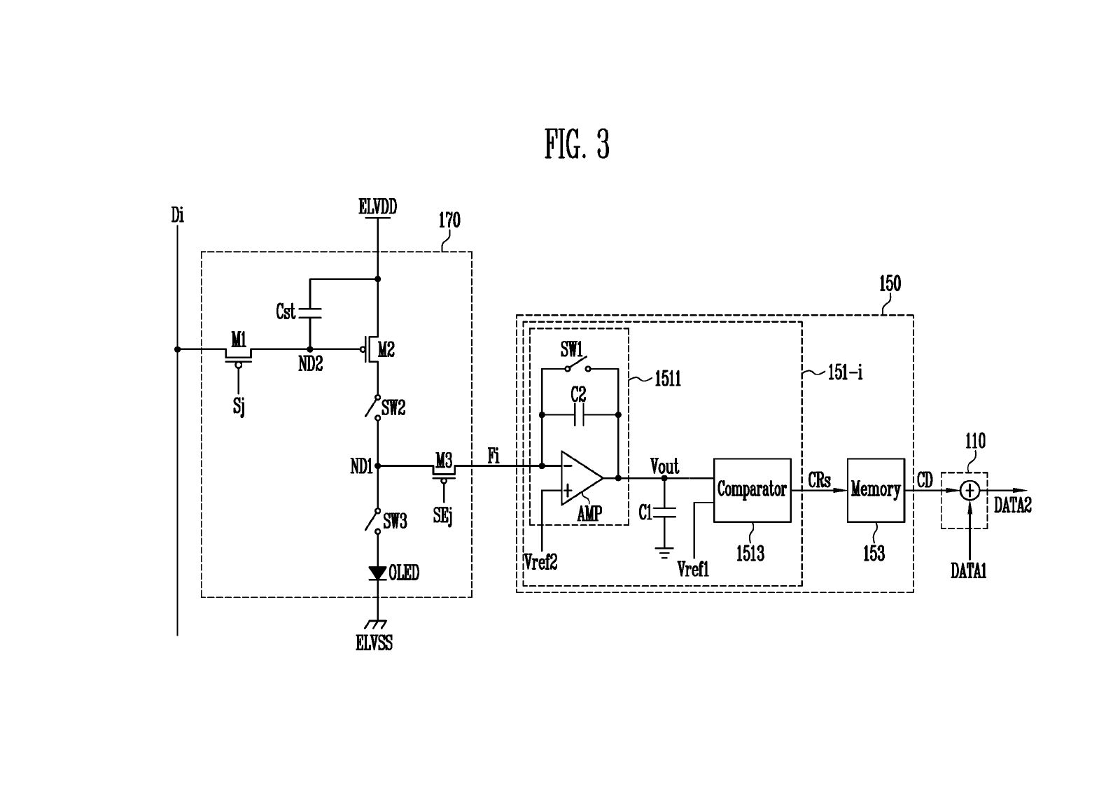

The timing controller 110 may convert a first data DATA1 received from the outside into a second data DATA2, based on a compensation data retrieved from a memory (153 of FIG. 3) included in the sensing unit 150, and supply the converted second data DATA2 to the data driver 120.

The data driver 120 may adjust the second data DATA2 received from the timing controller 110 under the control of the timing controller 110, i.e., in response to the data driving control signal DCS output from the timing controller 110, and the adjusted second data DATA2 to data lines D1 to Dm.

The scan driver 120 may sequentially supply a scan signal to the scan lines S1 to Sn under the control of the timing controller 110, i.e., in response to the scan driving control signal SCS output from the timing controller 110.

The sensing control line driver 140 may progressively supply a sensing control signal to sensing control lines SE1 to SEn under the control of the timing controller 110, i.e., in response to the sensing control line driving control signal SCCS.

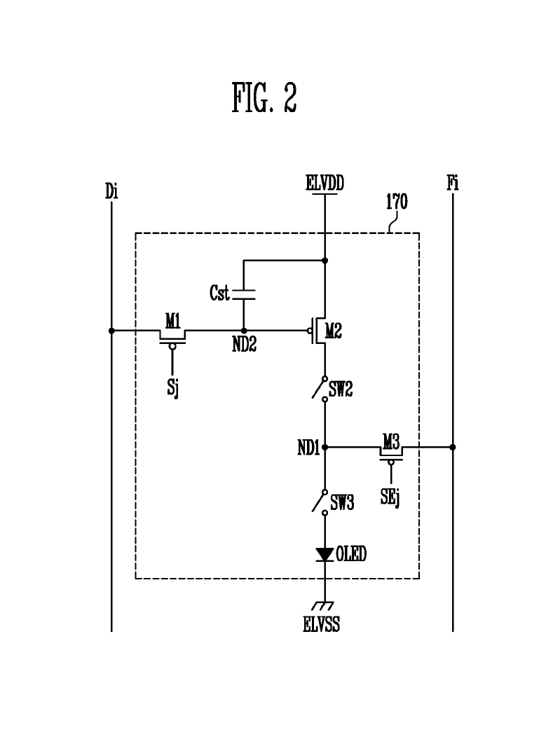

The sensing unit 150 may sense degradation information of an organic light emitting diode OLED included in each pixel 170 and threshold voltage/mobility information of a driving transistor, i.e., a second transistor (M2 of FIG. 2) included in each pixel 170, store a compensation data CD related to the sensed information, and supply the stored compensation data CD to the timing controller 110. The sensing unit 150 may sense the degradation information of the organic light emitting diode OLED included in each pixel 170 during a first sensing period, and sense the threshold voltage/mobility of the driving transistor included in each pixel 170 during a second sensing period.

To this end, the sensing unit 150 may include sensing circuits coupled to feedback lines F1 to Fm. The structure and operation of the sensing unit 150 will be described in detail with reference to FIG. 3.

As used herein, the “first sensing period” means a period of sensing the degradation information of the organic light emitting diode OLED included in the pixel 170 and correcting the value of the compensation data CD based on the sensed result. As used herein, the “second sensing period” means a period of sensing the threshold voltage/mobility information of the driving transistor, i.e., the second transistor M2 included in the pixel 170 and correcting the value of the compensation data CD based on the sensed result. The “display period” means a period in which the pixel 170 emits light with a luminance level corresponding to a data signal output from the data driver 120, and the “reset period” means a period of discharging a voltage charged in a second capacitor C2 included in an integrator (1511 of FIG. 3). Here, the reset period may be set as a period posterior to the first or second sensing period.

The pixel unit 160 may include pixels 170 arranged at intersection portions of the data lines D1 to Dm, the feedback lines F1 to Fm, the scan lines S1 to Sn and SE1 to SEn. Here, the data lines D1 to Dm and the feedback lines F1 to Fm may be arranged along vertical lines, and the scan lines S1 to Sn and the sensing control lines SE1 to SEn are arranged along horizontal lines.

The pixels 170 emit light with various colors such as red, green, blue and white according to the kind of organic light emitting diode OLED that is included in each pixel 170 or the color of a color filter formed on the organic light emitting diode OLED.

FIG. 2 is a circuit diagram illustrating in detail the pixel shown in FIG. 1. FIG. 2 shows a pixel disposed at an intersecting portion of an i-th (i is a natural number greater than 0) vertical line and a j-th (j is a natural number greater than 0) horizontal line.

Referring to FIG. 2, the pixel 170 may include an organic light emitting diode OLED, a plurality of transistors M1 to M3, and a storage capacitor Cst.

The organic light emitting diode OLED may be coupled between a first node ND1 and a second power source ELVSS. The organic light emitting diode OLED emits light with a luminance corresponding to current flowing from the first node ND1 to the second power source ELVSS.

The first transistor M1 may be coupled between a data line Di and a second node ND2. The first transistor M1 is turned on in response to a scan signal supplied through a scan line Sj.

The storage capacitor Cst may be coupled between a first power source ELVDD and the second node ND2. When the first transistor M1 is turned on, the storage capacitor Cst charges a voltage corresponding to the data signal supplied through the data line D1.

The second transistor M2 may supply current corresponding to the voltage charged in the storage capacitor Cst from the first power source ELVDD to the first node ND 1. The third transistor M3 is turned off during the display period, and thus the organic light emitting diode OLED emits light with a luminance corresponding to the current supplied from the second transistor M2.

The third transistor M3 may be coupled between a feedback line Fi and the first node ND 1. The third transistor M3 is turned on in response to a sensing control signal supplied from a sensing control line SEj. The sensing control signal is supplied during the first or second sensing period, and thus the third transistor M3 is turned on during the first or second sensing period.

The pixel 170 may further include a second switch SW2. The second switch SW2 is coupled between the second transistor M2 and the first node ND1. The second switch SW2 is turned on during the display period or the second sensing period so as to allow the second transistor M2 and the first node ND1 to be coupled to each other. The second switch SW2 is turned off during the first sensing period so as to block the coupling between the second transistor M2 and the first node ND 1.

The pixel 170 may further include a third switch SW3. The third switch SW3 may be coupled between the first node ND1 and an anode electrode of the organic light emitting diode OLED. The third switch SW3 is turned on during the display period or the first sensing period so as to allow the first node ND1 and the anode electrode of the organic light emitting diode OLED to be coupled to each other. On the contrary, the second switch SW2 is turned off during the second sensing period so as to block the coupling between the second transistor M2 and the first node ND1.

Alternatively, the pixel 170 may not include the third switch SW3, and the voltage of the second power source ELVSS may be increased during the second sensing period so that the current flowing from the first node ND 1 to the second power source ELVSS through the organic light emitting diode OLED is cut off

The pixel shown in FIG. 2 is merely a representative embodiment for better understanding the technical spirit of the present disclosure, and the technical spirit of the present disclosure is not limited thereto.

FIG. 3 is a circuit diagram illustrating a connection among the pixel, the sensing unit and the timing controller (shown in FIG. 1). For convenience of illustration, only the pixel 170 disposed at the intersection portion of the i-th vertical line and the j-th horizontal line, a sensing circuit 151-i corresponding to the i-th vertical line in the sensing unit 150, and a portion of the timing controller 110 are shown in FIG. 3.

The sensing circuit 151-i is coupled to a feedback line Fi. The sensing circuit 151-i includes an integrator 1511, a comparator 1513 and a first capacitor C1.

The integrator 1511 integrates current supplied from the feedback line Fi during a predetermined period, e.g., the first or second sensing period in which the third transistor M3 is turned on, and outputs an output voltage Vout that is generated based on the integrated result. The integrator 1511 includes an amplifier AMP and a second capacitor C2.

A first input terminal of the amplifier AMP is coupled to the feedback line Fi, and a second input terminal of the amplifier AMP is coupled to a second reference power source Vref2. An output terminal of the amplifier AMP is coupled to the comparator 1513. The second capacitor C2 is coupled between the first input terminal and output terminal of the amplifier AMP.

The integrator 1511 may further include a first switch SW1. The first switch SW1 is coupled between the first input terminal and output terminal of the amplifier AMP. The first switch SW1 is turned on during the reset period. The first switch SW1 resets the integrator 1511 during the reset period. In other words, the first switch SW1 discharges the voltage that is stored in the second capacitor C2 during the reset period.

The integrator 1511 integrates current supplied to the feedback line Fi during the first sensing period. In this case, the amplifier AMP may be operated as a kind of current source. On the contrary, the integrator 1511 integrates current supplied from the feedback line Fi during the second sensing period.

The first capacitor C1 may arbitrarily store the output voltage Vout of the integrator 1511. The first capacitor C1 is coupled between the output terminal of the amplifier AMP and a ground power source. The output voltage Vout arbitrarily charged in the first capacitor C1 is discharged during the reset period.

The comparator 1513 may compare the output voltage Vout stored in the first capacitor C1 with the voltage of a first reference power source Vref1, and output a comparison result signal CRS to a memory 153 based on the comparison.

In one embodiment, when the output voltage Vout is less than the voltage of the first reference power source Vref1, the comparator 1513 outputs a comparison result signal CRS for increasing the value of the compensation data CD. On the other hand, when the output voltage Vout is greater than the voltage of the first reference power source Vref1, the comparator 1513 outputs a comparison result signal CRS for decreasing the value of the compensation data CD.

The memory 153 may store a compensation data CD related to degradation information of the organic light emitting diode OLED and threshold voltage/mobility information of the driving transistor, i.e., the second transistor M2. The memory 153 corrects the value of a compensation data CD stored in response to the comparison result signal CRS output from the comparator 1513. The memory 153 supplies, to the timing controller 110, a compensation data CD corresponding to the pixel to which a data signal is to be supplied during the display period. In this case, the timing controller 110 outputs, to the data driver 120, a second data DATA2 obtained by adding a first data DATA1 supplied from the outside and the compensation data CD.

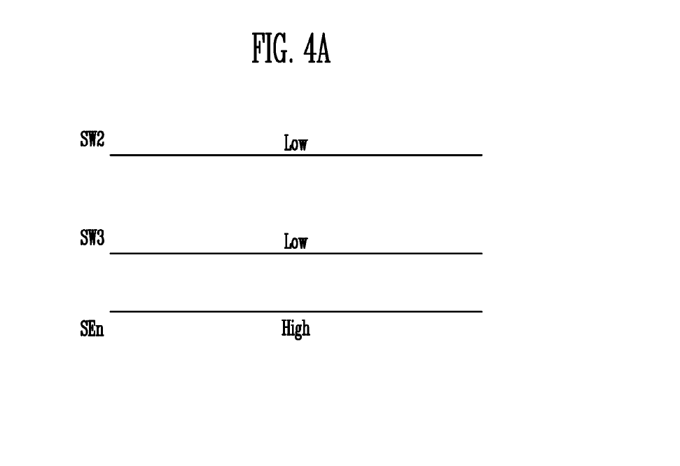

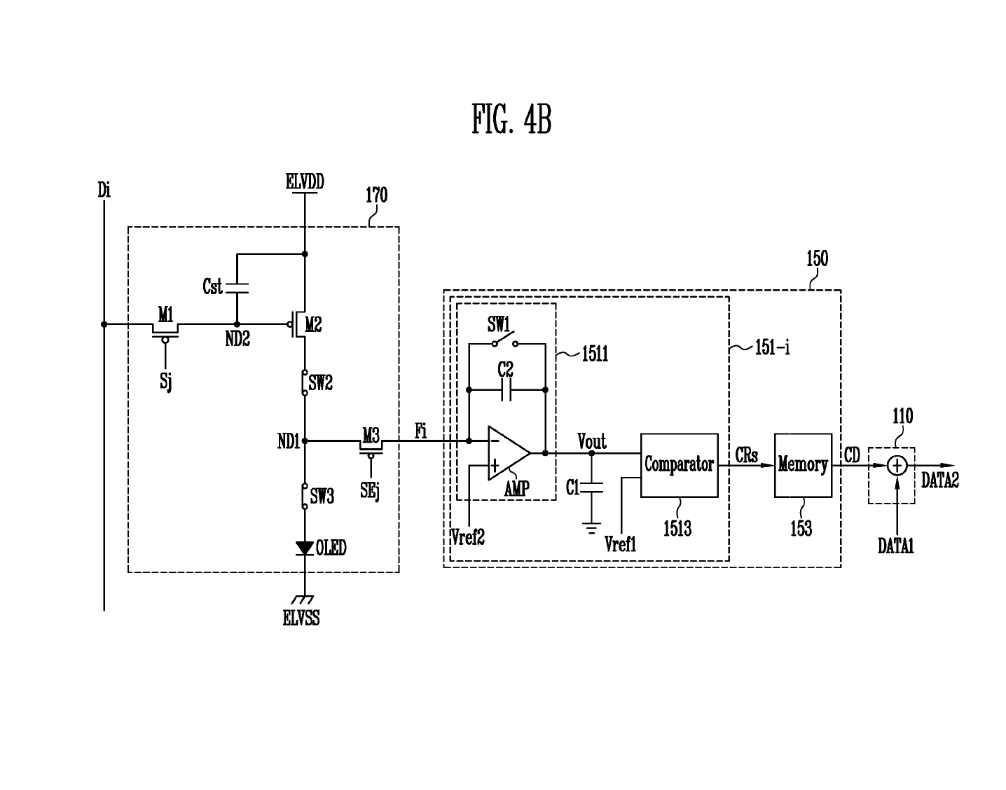

FIG. 4A is a waveform diagram of control signals supplied to the pixel, the sensing unit and the timing controller, shown in FIG. 3, during the display period. FIG. 4B is a circuit diagram illustrating operations of the pixel, the sensing unit and the timing controller, shown in FIG. 3, during the display period.

Referring to FIGS. 4A and 4B, during the display period, the second and third switches SW2 and SW3 are turned on, and the third transistor M3 is turned off

The coupling between the pixel 170 and the sensing unit 150 is blocked during the display period. Thus, the sensing unit 150 is not operated, and the pixel 170 emits light with a luminance corresponding to the data signal supplied through the data line Di.

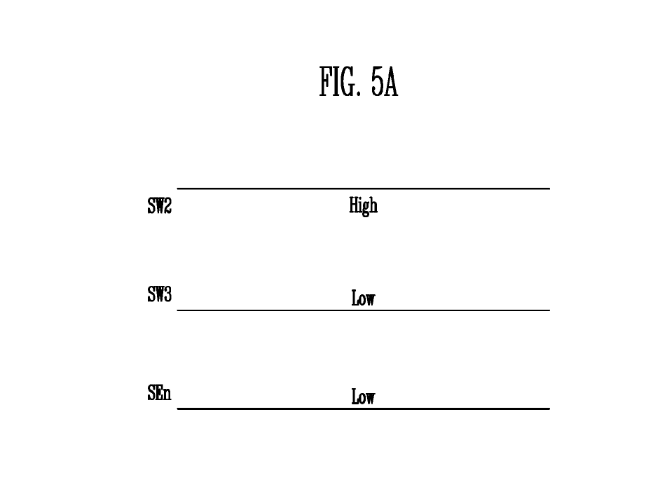

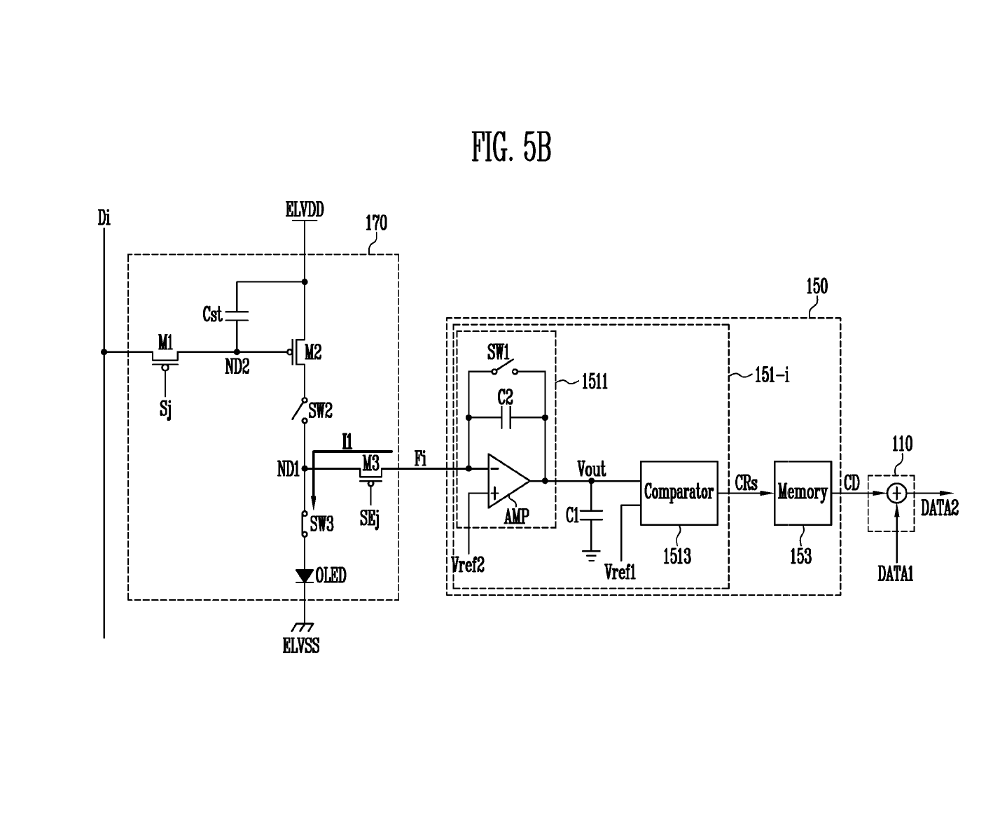

FIG. 5A is a waveform diagram of control signals supplied to the pixel, the sensing unit and the timing controller, shown in FIG. 3, during the first sensing period. FIG. 5B is a circuit diagram illustrating operations of the pixel, the sensing unit and the timing controller, shown in FIG. 3, during the first sensing period.

Referring to FIGS. 5A and 5B, during the first sensing period, the second switch SW2 is turned off, and the third switch SW3 and the third transistor M3 are turned on.

The amplifier AMP is operated as a kind of current source during the first sensing period. That is, current I1 flows from the integrator 1511 to the second power source ELVSS through the organic light emitting diode OLED.

The integrator 1511 may generate an output voltage Vout by integrating the current I1. The comparator 1513 may compare the output voltage Vout with the voltage of the first reference power source Vref1, and output a comparison result signal CRS to the memory 153, based on the compared result. Here, the voltage of the first reference power source Vref1 is set to be equal to the output voltage Vout obtained by integrating the current I1 during the first sensing period when the organic light emitting diode OLED is not degraded.

As the organic light emitting diode OLED degrades over time, the output voltage Vout deviates from the voltage of the first reference power source Vref1. In this case, the comparator 1513 outputs, to the memory 153, a comparison result signal CRS that may used to increase the value of the compensation data CD.

On the contrary, when the output voltage Vout is higher than the voltage of the first reference power source Vref1, the comparator 1513 outputs, to the memory 153, a comparison result signal CRS for decreasing the value of the compensation data CD.

Then, during the display period, the timing controller 110 may supply a second data DATA2 obtained by adding the first data DATA1 and the compensation data CD to the data driver 120. The data driver 120 supplies, to the pixel 170, a data signal corresponding to the second data DATA2. That is, the pixel 170 receives a data signal supplied in consideration of the degradation information of the organic light emitting diode OLED. Thus, the pixel 170 can emit light with exact luminance, regardless of the degradation of the organic light emitting diode OLED.

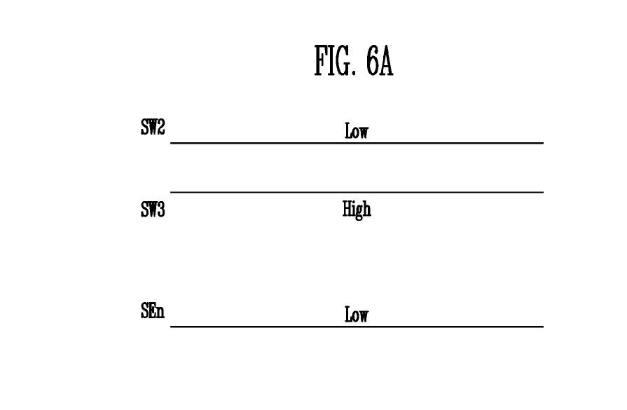

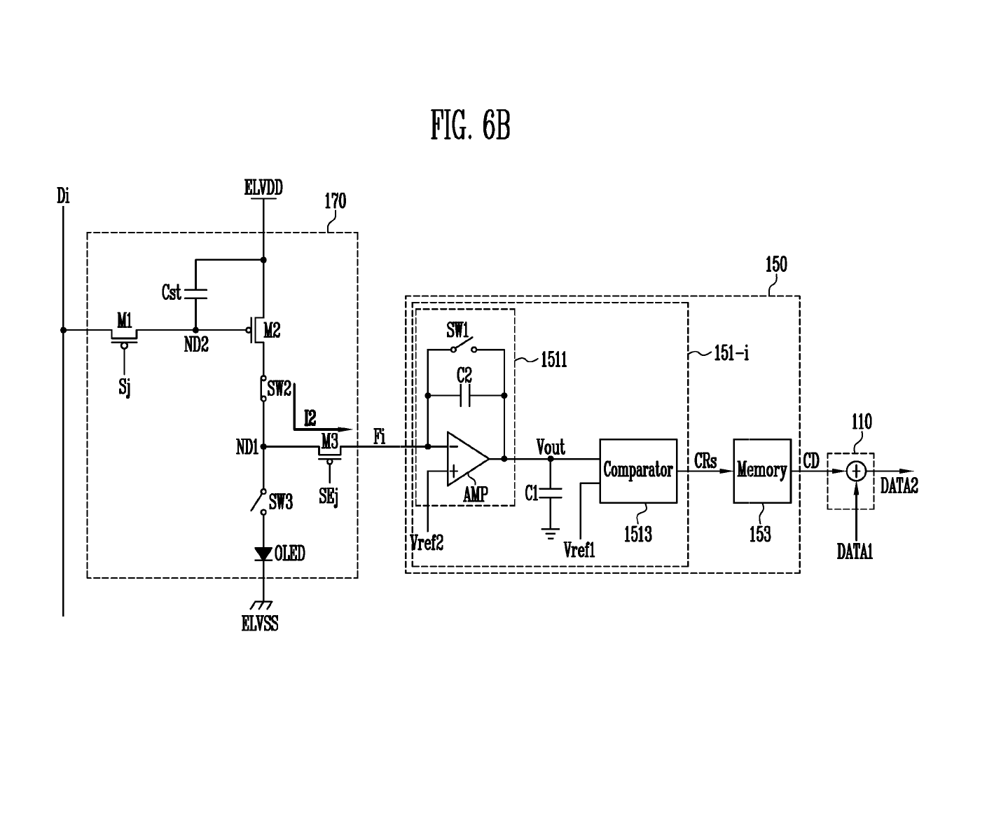

FIG. 6A is a waveform diagram of control signals supplied to the pixel, the sensing unit and the timing controller, shown in FIG. 3, during the second sensing period. FIG. 6B is a circuit diagram illustrating operations of the pixel, the sensing unit and the timing controller, shown in FIG. 3, during the second sensing period.

Referring to FIGS. 6A and 6B, during the second sensing period, the third switch SW3 is turned off, and the second switch SW2 and the third transistor M3 is turned on. Current I2 corresponding to the data signal supplied through the data line Di during the second sensing period is supplied to the sensing circuit 151-i through the feedback line Fi.

The integrator 1511 may generate an output voltage Vout by integrating the current I2. The comparator 1513 compares the output voltage Vout with the voltage of the first reference power source Vref1, and outputs a comparison result signal CRS to the memory 153. The value of the comparison result signal CRS is based on the comparison. Here, the voltage of the first reference power source Vref1 is set to be equal to the output voltage obtained by integrating the current I2 during the second sensing period when the driving transistor, i.e., the second transistor M2, has not degraded yet.

With degradation of the second transistor M2, the output voltage Vout and the voltage of the first reference power source Vref1 become different from each other. When the output voltage Vout is lower than the voltage of the first reference power source Vref1, the comparator 1513 outputs, to the memory 153, a comparison result signal for increasing the value of the compensation data CD. On the contrary, when the output voltage Vout is higher than the voltage of the first reference power source Vref1, the comparator 1513 outputs, to the memory 153, a comparison result signal CRS for decreasing the value of the compensation data CD.

The voltage of the first reference power source Vref1 during the first sensing period may be set to be different from that of the first reference power source Vref1 during the second sensing period. Similarly, the voltage of the second reference power source Vref2 during the first sensing period may be set to be different from that of the second reference power source Vref2 during the second sensing period.

Then, during the display period, the timing controller 110 may supply a second data DATA2 that is obtained by adding the first data DATA1 and the compensation data CD to the data driver 120. The data driver 120 may supply, to the pixel 170, a data signal corresponding to the second data DATA2. That is, the pixel 170 receives a data signal supplied in consideration of the threshold voltage/mobility information of the second transistor M2. This way, the pixel 170 can emit light with the desired luminance level even when the second transistor M2 is degraded or otherwise imperfect.

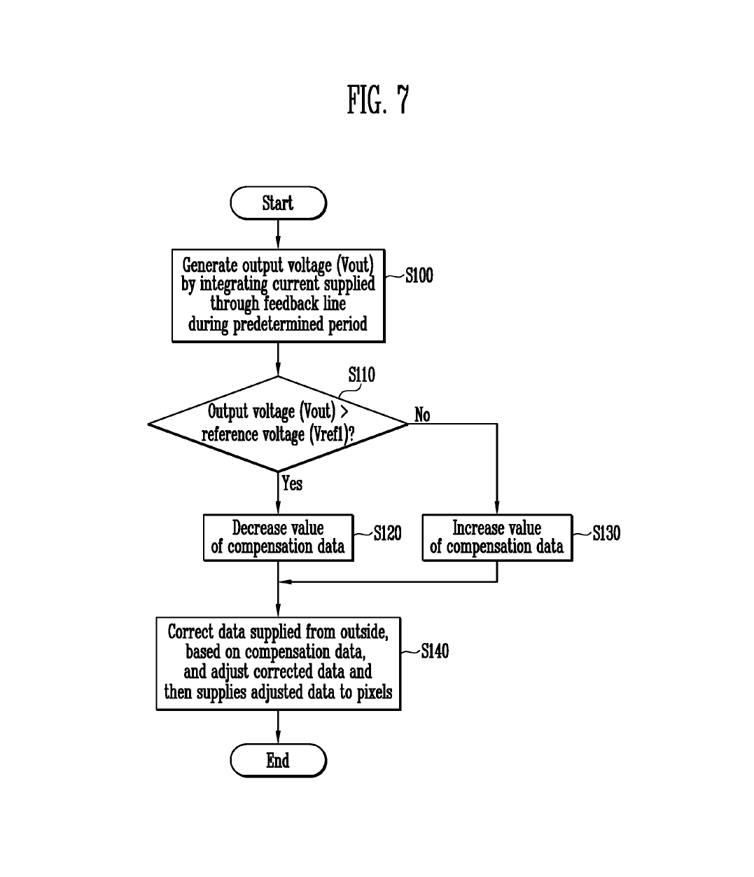

FIG. 7 is a flowchart illustrating a method for driving the organic light emitting display according to an embodiment of the inventive concept.

Referring to FIG. 7, the integrator 1511 generates an output voltage Vout by integrating current I1 or I2 supplied through the feedback line Fi during a predetermined period, e.g., the first or second sensing period (S100).

The comparator 1513 compares the output voltage Vout of the integrator 1511 with the voltage of the first reference power source Vref1, and outputs a comparison result signal CRS to the memory 153, based on the compared result (S110).

The memory 153 may correct a compensation data CD stored in response to the comparison result signal CRS. Specifically, the memory 153 decreases the value of the compensation data CD when the output voltage Vout is higher than the voltage of the first reference power source Vref1 (S120), and increases the value of the compensation data CD when the output voltage Vout is lower than the voltage of the first reference power source Vref1 (S130). If the output voltage Vout is substantially equal to the first reference power source Vref1, the compensation data CD that is stored in the memory 153 may remain unchanged.

The timing controller 110 may supply a second data DATA2 obtained by correcting a first data DATA1 received from the outside by using the compensation data CD stored in the memory 153. The data driver 120 may adjust the second data DATA2 and supply the adjusted second data DATA2 to the pixels 170 (S140).

Accordingly, each pixel 170 can emit light with the desired level of luminance, regardless of the difference between the degradation of the organic light emitting diode and the threshold voltage/mobility of the second transistor.

In summary, an organic light emitting display generally does not display an image with a desired luminance over a long period of time. This is due to a change in efficiency caused by the degradation of an organic light emitting diode. The organic light emitting diode degrades over time and accordingly, the luminance level of the emitted light corresponding to the same data signal may change (e.g., decrease) over time. When this happens, the image that is displayed may not have uniform luminance due to the non-uniformity of the threshold voltage/mobility of a driving transistor included in each pixel.

The organic light emitting display and a method for driving the same according to the present disclosure enables an image to be displayed at consistent luminance levels even over a long time by incorporating a sensing unit that is configured to compensate for the degradation of the organic light emitting diode and the threshold voltage/mobility of the driving transistor.

Example embodiments have been disclosed herein. The specific terms employed in the disclosure are to be interpreted in a generic and descriptive sense only and not for purpose of limitation the inventive concept. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. An organic light emitting display, comprising:
a pixel unit configured to include pixels arranged at intersection portions of data lines, feedback lines, scan lines and sensing control lines;
a data driver configured to supply data signals to the data lines;
a scan driver configured to sequentially supply scan signals to the scan lines;
a sensing control line driver configured to sequentially supply a sensing control signal to the sensing control lines; and
a sensing unit configured to include sensing circuits coupled to the feedback lines,
wherein at least one of the sensing circuits is disposed on an i-th (i is a natural number greater than 0) vertical line and includes:
an integrator configured to integrate current supplied from an i-th feedback line;
a first capacitor configured to store an output voltage of the integrator; and
a comparator configured to compare the output voltage stored in the first capacitor and the voltage of a first reference power source, and output a comparison result signal based on the comparison.

2. The organic light emitting display of claim 1, wherein the sensing unit further includes a memory configured to store a compensation data related to degradation information of an organic light emitting diode included in each pixel and threshold voltage/mobility of a driving transistor included in each pixel, and correct the compensation data, in response to the comparison result signal.

3. The organic light emitting display of claim 2, further comprising a timing controller configured to correct a first data received from the outside of the organic light emitting display based on the compensation data stored in the memory, and supply the corrected first data as a second data to the data driver.

4. The organic light emitting display of claim 3, wherein the data driver supplies, to the data lines, a data signal corresponding to the second data.

5. The organic light emitting display of claim 1, wherein the integrator includes:
an amplifier configured to have a first input terminal coupled to the i-th feedback line, a second input terminal coupled to a second reference power source, and an output terminal coupled to the comparator; and
a second capacitor coupled between the first input terminal and the output terminal.

6. The organic light emitting display of claim 5, wherein the integrator further includes a first switch coupled between the first input terminal and the output terminal, the first switch being turned on during a reset period.

7. The organic light emitting display of claim 1, wherein a pixel disposed at an intersection portion of the i-th vertical line and a j-th (j is a natural number greater than 0) horizontal line among the pixels includes:
an organic light emitting diode coupled between a first node and a second power source;
a first transistor coupled between an i-th data line and a second node, the first transistor being configured to turn on in response to the scan signal supplied through a j-th scan line;
a storage capacitor coupled between a first power source and the second node;
a second transistor configured to supply current corresponding to a voltage charged in the storage capacitor from the first power source to the second power source through the second node; and
a third transistor coupled between an i-th feedback line and the first node, the third transistor configured to turn on in response to the sensing control signal supplied through a j-th sensing control line.

8. The organic light emitting display of claim 7, wherein the pixel further includes a second switch coupled between the second transistor and the first node, the second switch being configured to turn off during a first sensing period.

9. The organic light emitting display of claim 7, wherein the pixel further includes a third switch coupled between the first node and the organic light emitting diode, the third switch being configured to turn off during a second sensing period.

10. The organic light emitting display of claim 7, wherein the voltage of the second power source is increased during the second sensing period so that current does not flow through the organic light emitting diode.

11. A method for driving an organic light emitting display, the method comprising:
generating an output voltage by integrating current supplied through a feedback line during a predetermined period;
comparing the output voltage with the voltage of a reference power source;
correcting a compensation data stored in a memory based on the comparison; and
correcting a data based on the compensation data, adjusting the corrected data, and supplying the adjusted data to pixels.

12. The method of claim 11, wherein the correcting of the compensation data includes:
decreasing the value of the compensation data when the output voltage is higher than the voltage of the reference power source; and
increasing the value of the compensation data when the output voltage is lower than the voltage of the reference power source.
